(19) United States
(12) Patent Application Publication
(10) Pub. No.: US 2006/0055328 A1
(43) Pub. Date: Mar. 16, 2006

(54) Electric lamp

(75) Inventor: Roland Rittner, Herbrechtingen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/212,779

(22) Filed: Aug. 29, 2005

(30) Foreign Application Priority Data
Sep. 10, 2004 (DE) 10 2004 044 369.6

(51) Int. Cl. H01J 61/36; H01J 61/20

(52) U.S. Cl. 313/623

(57) ABSTRACT

An electric lamp has at least one molybdenum foil seal for a lamp vessel (30, 40) and at least one slotted metal pin (35, 44), the at least one slotted metal pin (35, 44) being electrically conductively connected to a molybdenum foil (32, 42) of the at least one molybdenum foil seal, characterized in that one end (321) of the molybdenum foil (32, 42) is arranged and fixed in the slot (350) in the at least one slotted metal pin (35, 44). The metal pin (35, 44) is preferably in the form of a power supply wire or a gas-discharge electrode.

### TECHNICAL FIELD

The invention relates to an electric lamp having at least one molybdenum foil seal for a lamp vessel and at least one slotted metal pin, the at least one slotted metal pin being electrically conductively connected to a molybdenum foil of the at least one molybdenum foil seal.

### BACKGROUND ART

A lamp of this type is disclosed, for example, in patent specification U.S. Pat. No. 2,219,438 which describes a lamp having a molybdenum foil seal for the lamp vessel, one end of the molybdenum foil of the molybdenum foil seal being connected to two metal foils which serve to aid welding and are themselves fixed in the slot in a slotted power supply wire by spot welding.

### DISCLOSURE OF THE INVENTION

The object of the invention is to provide an electric lamp of this generic type which has a simplified power supply line.

According to the invention, this object is achieved by an electric lamp having at least one molybdenum foil seal for a lamp vessel and at least one slotted metal pin, the at least one slotted metal pin being electrically conductively connected to a molybdenum foil of the at least one molybdenum foil seal, wherein one end of the molybdenum foil is arranged and fixed in the slot in the at least one slotted metal pin. Particularly advantageous embodiments of the invention are described in the dependent patent claims.

The electric lamp according to the invention has at least one molybdenum foil seal for a lamp vessel and at least one slotted metal pin, the at least one slotted metal pin being electrically conductively connected to a molybdenum foil of the at least one molybdenum foil seal. According to the invention, one end of the molybdenum foil is arranged and fixed in the slot in the at least one slotted metal pin. As a result, the metal foils which serve to aid welding according to the prior art can be dispensed with. It has been shown that the end of the abovementioned molybdenum foil which is arranged in the slot can be reliably connected to the power supply wire by means of a direct welded connection, that is to say without the use of a solder or other welding means. This welded connection is preferably made with the aid of a laser.

The metal pin is preferably composed of a metal from the group comprising tungsten, a tungsten alloy, molybdenum and a molybdenum alloy, and, according to the preferred exemplary embodiments, is either in the form of a power supply wire or a gas-discharge electrode.

### BRIEF DESCRIPTION OF THE DRAWINGS

The invention will be explained in greater detail below with reference to one preferred exemplary embodiment. In the drawings:

FIG. 1 shows a side view of a slotted power supply wire,

FIG. 2 shows a side view of the power supply wire depicted in FIG. 1 with a molybdenum foil arranged in the slot,

FIG. 3 shows a schematic illustration of an incandescent lamp according to the invention having a molybdenum foil seal for the lamp vessel and the power supply line depicted in FIG. 2, and

FIG. 4 shows a schematic illustration of a discharge lamp according to the invention having a molybdenum foil seal for the lamp vessel and the power supply line or gas-discharge electrode depicted in FIG. 2.

### BEST MODE FOR CARRYING OUT THE INVENTION

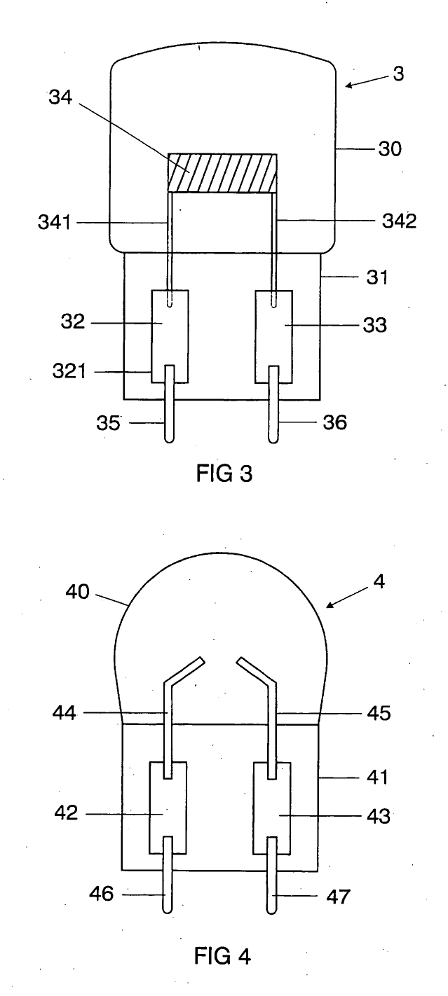

The incandescent lamp 3 illustrated in FIG. 3 has a lamp vessel 30 made of quartz glass with a sealed end 31 which has two molybdenum foils 32, 33 embedded in the sealed end 31. An incandescent filament 34, whose outgoing filament sections 341, 342 are each welded to one of the molybdenum foils 32 or 33, is arranged within the lamp vessel 30. The end 321 of the molybdenum foils 32, 33 which is remote from the interior of the lamp vessel 30 is respectively connected to a power supply wire 35 or 36 which is made of molybdenum and is passed out of the sealed end 31 of the lamp vessel 30 by the abovementioned end of the molybdenum foil 32 or 33 being fixed in a slot in the power supply wire 35 or 36.

The discharge lamp 4 illustrated in FIG. 4 has a lamp vessel 40 made of quartz glass with a sealed end 41 which has two molybdenum foils 42, 43 embedded in the sealed end 41. Two gas-discharge electrodes 44, 45, which are made of tungsten wire and are each welded to one of the molybdenum foils 42 or 43, are arranged within the lamp vessel 40. To this end, the molybdenum foils 42, 43 are each arranged in a slot in the gas-discharge electrodes 44, 45 and are preferably welded to them by means of a laser. The other end of the molybdenum foils 42, 43, which is remote from the interior of the lamp vessel 40, is respectively connected to a power supply wire 46 or 47 which is made of molybdenum and is passed out of the sealed end 41 of the lamp vessel 40 by the abovementioned end of the molybdenum foil 42 or 43 being fixed in a slot in the power supply wire 46 or 47.

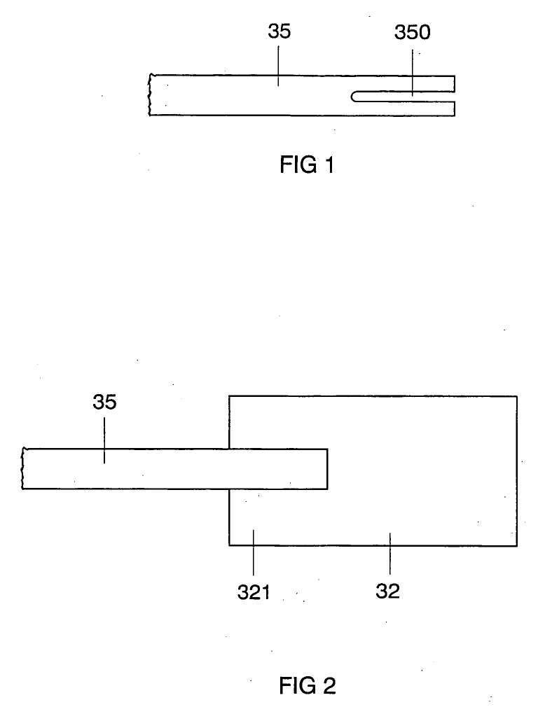

Details of the connections between the molybdenum foils 32, 33, 42, 43 and the power supply wires 35, 36, 46, 47 or the gas-discharge electrodes 44, 45 are illustrated with reference to the molybdenum foil 32 and the power supply wire 35 in FIGS. 1 and 2 in a manner representative of the connections between the other molybdenum foils 33, 42, 43 and the corresponding power supply wires 36, 46, 47 and gas-discharge electrodes 44, 45.

FIG. 1 shows the power supply wire 35 of the lamp depicted in FIG. 3 before said wire is installed in the lamp vessel. It is composed of molybdenum and has a thickness of 0.78 mm. A slot 350 which extends approximately 2 mm in the longitudinal direction of the power supply wire 35 is located at one end of the power supply wire 35. The slot 350 was produced by means of a laser. The width of the slot 350 is slightly greater than the thickness of the molybdenum foil 32 whose end 321 is arranged in the slot 350 in accordance with FIG. 2. The thickness of the molybdenum foil is 27 micrometers.

In order to fix the molybdenum foil 32 to the power supply wire 35, the end 321 of the molybdenum foil 32 is pushed into the slot 350 and the slotted section of the power supply wire 35 is then pressed together so that an interlocking connection is produced between the end 321 of the molybdenum foil 32 and the power supply wire. The power supply wire 35 and the end 321 of the molybdenum foil are subsequently connected by one or more weld spots which are produced by means of laser, for example. The weld spot or spots can be made along the side of the slot 350 and the area of contact between the molybdenum foil 32 and the power supply wire. However, it is also possible to weld through the middle of the power supply wire 35. Resistance welding is also possible. In an analogous manner to this, the end of the molybdenum foil 42 which is opposite the power supply line 46 is connected to the gas-discharge electrode 44 by this end of the molybdenum foil 42 being inserted into a slot in the gas-discharge electrode 44. The end of the molybdenum foil 42 which is arranged in the slot in the gas-discharge electrode 44 is then welded by one or more weld spots, as has been described above for connecting the power supply line 35 and the molybdenum foil 32. However, the previous operation of pressing the slotted electrode section together is dispensed with on account of the risk of the tungsten electrode 44 fracturing. Apart from this, the technique for producing a connection between the molybdenum foil and the gas-discharge electrodes is identical to the technique for producing a connection between the molybdenum foil and the power supply wire.

What is claimed is:

1. An electric lamp having at least one molybdenum foil seal for a lamp vessel and at least one slotted metal pin, the at least one slotted metal pin being electrically conductively connected to a molybdenum foil of said at least one molybdenum foil seal, wherein one end of said molybdenum foil is arranged and fixed in the slot in said at least one slotted metal pin.

2. The electric lamp as claimed in claim 1, wherein said metal pin is in the form of a power supply wire.

3. The electric lamp as claimed in claim 1, wherein said metal pin is in the form of a gas-discharge electrode.

4. The electric lamp as claimed in claim 1, wherein said metal pin is composed of a metal from the group comprising tungsten, a tungsten alloy, molybdenum and a molybdenum alloy.

5. The electric lamp as claimed in claim 1, wherein there is a direct welded connection between the molybdenum foil and the slotted metal pin.

6. The electric lamp as claimed in claim 2, wherein there is a direct welded connection between the molybdenum foil and the slotted metal pin.

7. The electric lamp as claimed in claim 3, wherein there is a direct welded connection between the molybdenum foil and the slotted metal pin.

8. The electric lamp as claimed in claim 4, wherein there is a direct welded connection between the molybdenum foil and the slotted metal pin.
